(19) United States
(12) Patent Application Publication
(10) Pub. No.: US 2018/0283509 A1
(43) Pub. Date: Oct. 4, 2018

(54) SHIFTING ELEMENT FOR SHIFTING A CAM SEGMENT

(71) Applicants: THYSSENKRUPP PRESTA TECCENTER AG, Eschen (LI); thyssenkrupp AG, Essen (DE)

(72) Inventor: Kay SIEGEL, Glauchau (DE)

(73) Assignees: THYSSENKRUPP PRESTA TECCENTER AG, Eschen (LI); thyssenkrupp AG, Essen (DE)

(21) Appl. No.: 15/760,742

(22) PCT Filed: Aug. 25, 2016
(86) PCT No.: PCT/EP2016/070046

§ 371 Date: Mar. 16, 2018

(30) Foreign Application Priority Data
Sep. 17, 2015 (DE) 10 2015 217 886.2

(51) Int. Cl. F16H 25/12; F16H 53/02; F01L 13/00

(52) U.S. Cl. CPC F16H 25/12; F01L 2013/0052; F01L 13/0036; F16H 53/025

(57) ABSTRACT

A shifting element and a shifting system may be employed to shift a cam segment along a shaft longitudinal axis of a shaft segment of a cam shaft that actuates valves of an internal combustion engine. The shifting element may have a guide groove for guiding an engagement element. The guide groove may extend along an outer peripheral surface of the shifting element at least in part. The guide groove may have an effective section for causing a rotational movement of the engagement element about a rotational axis of the engagement element. The rotational axis of the engagement element may extend orthogonally to a rotational axis of the shifting element. Further, the effective section may include a contact element for eccentrically contacting the engagement element.

The present invention relates to a shifting element as well as a shifting system for shifting a cam segment along a shaft longitudinal axis of a shaft segment of a cam shaft. Moreover, the invention relates to a cam shaft for actuating valves of an internal combustion engine, wherein the cam shaft has at least one shaft segment, a cam segment which is adapted to be shifted along a shaft axis of the shaft segment, and a shifting element for shifting the cam segment.

It is basically known that cam shafts control the gas exchange and thus the combustion of an internal combustion engine of a motor vehicle. They are driven by the crankshaft. Their rotational movement consequently stands in a precisely defined relation to the rotational movement of the crankshaft and thus to the position of the pistons in the cylinders. For the variable valve control of the internal combustion engine it is basically known how to shift the cam segments of the cam shaft axially along the shaft segment of the cam shaft so that different cam tracks come into engagement with, for example, a cam follower, in order to initiate different valve strokes. Thus, it should furthermore be considered to be basically known that a cam segment has, for example, at least two cam tracks situated axially next to each other, whereby it is also conceivable that a cam segment has more than two cam tracks, advantageously three cam tracks, at least one of the cam tracks making possible a zero stroke. In order to shift the cam segments axially along the shaft segment of the cam shaft, a shifting element is consequently used, which in known manner comprises a groove in which a pin element, such as an actuator, is adapted to be received. During the axial shifting of the cam segment or the cam piece by means of the actuator with a known pin shape, wearing of the pin making contact with the wall of the guide groove of the shifting element can occur as one drawback. When the pin is inserted into the guide groove or adjustment groove of the cam segment, the pin is immovable, that is, at rest. When the pin makes contact with the guide groove, especially a wall of the guide groove, there exists a differential speed between the groove contour or the guide groove and the pin, which causes an increased wear at least on the pin or also on the guide groove contour.

DE 10 2012 014 778 A1 shows for example a valve train, comprising a cam shaft and at least two cam carriers. A longitudinal toothing of the cam carrier engages with a corresponding external toothing of the cam shaft, such that a lengthwise shifting of the cam carrier on the cam shaft is made possible, while at the same time a rotationally locked connection occurs in the circumferential direction. The cam carrier itself possesses several different cam segments with different cam contours, bringing about different actuating characteristics for the gas exchange valves. As is already known from the prior art, pick-off means or cam followers, such as for example finger-type rockers, which actuate the provided gas exchange valves engage on these cam contours. Advantageously, the different actuating characteristics of the gas exchange valves can adjust different valve strokes, according to the power demand of the internal combustion engine, which are in an operative connection with a lift valve. The different cam contours are adjusted by means of the axial shifting of the cam carrier on the cam shaft between at least two end positions. The shifting of the cam carrier itself is initiated by an actuator, which is electrically operated, for example. A pin of the actuator consequently engages with the groove contour of the cam carrier, which is in rotational movement about the longitudinal axis of the cam shaft, so that a shifting of the cam carrier in the axial direction is made possible in this way. Upon contacting of the pin with the wall of the groove contour, a wearing of the pin is promoted on account of the differential velocity between the groove contour and the pin. This causes an abrasion of pin material at the peripheral wall of the pin, such that an unwanted play is produced or intensified between the pin of the actuator and the wall of the groove contour, such that a reliable pin guidance within the groove contour of the guide groove is no longer assured.

DE 10 2009 008 422 A1 discloses a valve train shifting device with a coupling unit. The valve train shifting device comprises at least one shifting anchor element, which is provided for a shifting movement, and a shifting element, which is provided for a coupling to a shifting gate of a cam element. The shifting element is at least partly designed as a sliding shoe. The shifting anchor element itself is at least partly designed as a shifting pin. The activating device of the valve train shifting device comprises a shifting unit with an activating actuator and a shifting gate with at least one slide track. The activating actuator comprises the shifting anchor element as well as the shifting element. In a shifting position in which the shifting anchor element is extended, the shifting element engages with the shifting gate, so that a rotational movement of the cam element is provided into the axially acting shifting force. By means of a coupling unit, the shifting anchor element and the shifting element are coupled and able to move relative to each other in three degrees of freedom. The three degrees of freedom are configured as mutually independent rotational movements between the shifting anchor element and the shifting element. The shifting element designed as a sliding shoe has a rotationally asymmetrical basic shape with two functional surfaces, which are designed as portions of a side surface of the shifting element. The functional surfaces are designed as contact surfaces between the shifting element and flanks of the slide track, which are exposed to a permanent rubbing and wearing upon engaging of the shifting element with the slide track. In this way, the possibility exists for a rubbing of the functional surfaces of the shifting element and the flanks of the slide track, so that once again an unwanted play may occur between the slide track and the shifting element.

The problem which the present invention proposes to solve is therefore to eliminate at least some of the above described drawbacks for a shifting element, especially a shifting system or valve train for the shifting of a cam segment along a shaft longitudinal axis of a shaft segment of a cam shaft. In particular, the problem of the present invention is to create a shifting element, a shifting system and a cam shaft for the actuating of valves of an internal combustion engine which enables in a simple and economical manner a shifting of the cam segment along the longitudinal axis of the cam shaft, wherein the unwanted occurrence of a gap causing play between the wall of the guide groove and the engagement element engaging with the guide groove is avoided.

The aforementioned problem is solved by a shifting element for shifting a cam segment along a shaft longitudinal axis of a shaft segment of a cam shaft with the features per claim 1, as well as a shifting system for shifting a cam segment along a shaft longitudinal axis of a shaft segment of a cam shaft with the features per claim 9. Moreover, the aforementioned problem is solved by means of a cam shaft for actuating of valves of an internal combustion engine with the features per claim 10. Further features and details of the invention will emerge from the subclaims, the specification, and the drawings. Features and details which are described in connection with the shifting element according to the invention are also of course applicable in connection with the shifting system according to the invention and/or the cam shaft according to the invention and vice versa, so that the individual aspects of the invention are and can be taken in mutual reference with regard to their disclosure.

The shifting element according to the invention for shifting a cam segment along a shaft longitudinal axis of a shaft segment of a cam shaft has a guide groove for guiding an engagement element, which extends along an outer peripheral surface of the shifting element at least in sections. The guide groove has at least one effective section for bringing about a rotational movement of the engagement element about its rotational axis, which extends orthogonally to a rotational axis of the shifting element. According to the invention, the effective section has a contact element for the eccentric contacting of the engagement element. The shaft segment comprises at least one shaft body, which is designed for example as a hollow shaft or a solid shaft. It is furthermore conceivable to arrange flanges or end pieces on the shaft body for the arranging of a drive shaft, for example, or other add-on components. Advantageously, the shifting element has for example a sleeve shape with a through borehole, through which the shaft segment of the cam shaft is adapted to be led. The cam segment has at least one cam track, also advantageously two or more cam tracks for actuating the inlet valves or outlet valves of an internal combustion engine. The engagement element is designed for example as a pin and engages at least partly with the guide groove of the shifting element. The engagement element for example is a component of an actuator, such as an electromagnetic actuator. The actuator has, for example, an electromagnet unit comprising a stator unit and an armature unit. The stator unit comprises a coil and a coil core, by means of which a magnetic field generated by the coil is intensified. The armature unit itself comprises, for example, a permanent magnet, which is connected to the pin. The effective section of the guide groove is advantageously a region or section or sector in which a rotational movement of the engagement element is generated or produced. Advantageously, a friction between the groove contour and the outer surface of the engagement element is minimized by virtue of a rotation of the engagement element within the guide groove about its rotational axis. Consequently, the rotation of the engagement element is advantageously produced by virtue of the contact of the engagement element with the contact element of the effective section. The contact element of the effective section is, for example, an element or section or a surface which advantageously stands in direct contact with a surface of the engagement element—at least temporarily and especially when the engagement element is inserted into the guide groove. Advantageously, then, the contact element is part of the effective section. Especially advantageously, the contact element comprises an abrasion-resistant material or an abrasion-resistant coating. It is also conceivable that the contact element comprises a material corresponding to the material of the shifting element. Advantageously, the arrangement of the contact element in the effective section of the guide groove enables an eccentric contacting of the engagement element by means of the contact element. Eccentric means in the context of the invention a contacting outside of the region of the central rotational axis of the engagement element. Thanks to this eccentric contacting of the engagement element, on the one hand the rotational movement of the engagement element is made possible. On the other hand, a possible abrasion of the material of the engagement element, caused for example by a slip occurring between the engagement element and the guide groove contour during the acceleration of the engagement element to a required rotational velocity, is advantageously moved to a noncritical region of the engagement element. By noncritical region in the context of the invention is meant a region or section of the engagement element which, despite material abrasion, does not allow any unwanted play between the peripheral wall of the engagement element and the wall, especially the side wall, of the guide groove. Hence, the rotation of the engagement element is advantageously produced not by means of a contact between the engagement element and a wall, especially a side wall, of the guide groove contour, but instead by means of a contact between a distal end or a distal end region of the engagement element and the contact element of the effective section. In this way, a differential velocity is advantageously minimized between the frictional pairs, i.e., the engagement element and the contact element, especially the guide groove, so that a wearing of the contact element or the guide groove as well as the engagement element is advantageously minimized, or even prevented.

It is furthermore conceivable that the effective section at least in sections is formed in an inserting sector of the guide groove, in which the engagement element is adapted to be inserted in the guide groove. Advantageously, therefore, the effective section extends at least in sections within the inserting sector or up to this inserting sector. It is furthermore conceivable that the effective section is formed advantageously entirely within the inserting sector.

In the context of the invention, it is furthermore conceivable that the effective section at least in sections is designed in an adjusting sector of the guide groove, in which the guide groove has a deviation from the direction of travel. Accordingly, the effective section extends at least in sections within the adjusting sector or as far as the adjusting sector. It is furthermore possible that the effective section is formed advantageously entirely within the adjusting sector. The adjusting sector is therefore advantageously a section in which the guide groove contour does not have a straight trend in the circumferential direction.

It is furthermore conceivable that the effective section at least in sections is formed in an entry sector of the guide groove, in which a continuous increasing of a groove bottom depth of the guide groove occurs. Accordingly, the effective section extends at least in sections within the entry sector or as far as the entry sector. Advantageously, the effective section is formed entirely in the entry sector. The entry sector is consequently a region of the guide groove in which a dropping of a bottom of the guide groove occurs, starting from a base circle level of the shifting element down to a defined bottom depth of the guide groove. The entry sector and also an exit sector formed in the guide groove are advantageously formed when the guide groove is made in the surface or the material of the shifting element. The entry sector is the starting region of the guide groove, while the exit sector forms the end region of the guide groove, insofar as the guide groove is not formed entirely in the peripheral wall of the shifting element. Advantageously, it is conceivable to form the effective section in the entry sector, at least in sections, especially when a sufficiently long contact time is required between the engagement element and the contact element. This is for example the case when, at high revolutions of the cam shaft and consequently of the shifting element, the contact time of the engagement element and the groove contour, especially the torque-triggering region for generating a rotational movement of the engagement element, is very short. Consequently, the entry region is used as an entering region for the engagement element, such that the contact element already comes into direct contact with the engagement element here—advantageously even before the engagement element has been inserted into the guide groove, especially as far as the bottom of the guide groove.

It is furthermore conceivable that the guide groove has a U-shaped guide groove contour, the contact element being formed on one wall of the guide groove. Advantageously, the wall is a side wall or a U-shaped leg of the guide groove contour or also the bottom of the guide groove contour. Advantageously, the contact element is formed as a protrusion or material raising, which extends from a wall, such as a side wall or the bottom of the guide groove contour into this guide groove contour guide groove contour. Advantageously, the contact element extends such that the engagement element—at least in the effective section—undergoes no direct contacting with one of the side walls of the guide groove contour or the bottom of the guide groove contour. It is also conceivable that the contact element is produced in the groove bottom by the forming of an indentation or recess or a cavity.

It is furthermore possible that the contact element is a material raising, which extends at least in sections asymmetrically to the guide groove bottom within a guide groove contour of the guide groove. Consequently, it is conceivable that the contact element for example partitions or passes through the guide groove contour, in any desired manner, such that a contact surface with the engagement element is formed—deviating from the groove bottom and from at least one side wall of the groove contour.

It is conceivable that the guide groove is Y-shaped, S-shaped, double S-shaped or XS-shaped. Consequently, the guide groove extends in any desired form in the circumferential direction around the shifting element. It is furthermore conceivable that the shifting element also has more than one guide groove, in particular two guide grooves. It is possible here for a first guide groove to serve for a movement of the shifting element and the cam segment connected to it in a first direction, and another guide groove to serve for a movement of the shifting element and the cam segment connected to it in a direction opposite the first direction.

It is conceivable that the shifting element is operatively connected to the cam segment by means of a guide sleeve. The guide sleeve here is advantageously a support element, which serves for receiving or joining together the shifting element and the cam segment in rotational locking. Advantageously, the torque transmission occurs starting from the shifting element to the guide sleeve and from there to the cam segment. It is conceivable that the shifting element and the cam segment are arranged axially next to each other on the guide sleeve, looking in the shaft longitudinal axis direction. Advantageously, the shifting element and also the cam segment are joined by rotational locking to the guide sleeve or shrink-fitted or press-fitted on this guide sleeve.

There is furthermore claimed a shifting system for shifting a cam segment of a cam shaft, wherein the shifting system comprises at least one shifting element of the aforementioned kind as well as an engagement element for engaging with the guide groove of the shifting element, wherein the engagement element is designed to be rotatable about its longitudinal axis. Advantageously, the engagement element is part of an actuator. Advantageously, the torque of the engagement element is created by means of the contact element of the effective section. The longitudinal axis of the engagement element is formed substantially orthogonal to the longitudinal axis of the shifting element, so that advantageously the engagement element can inserted along its longitudinal axis into the guide groove. Upon inserting the engagement element into the guide groove or upon moving the engagement element out from the guide groove, the engagement element is moved in translation along its longitudinal axis. The engagement element, when inserted into the guide groove, impinges in decentralized manner against the contact element in the effective section, which is formed for example in the entry sector, inserting sector or adjusting sector of the guide groove. In the shifting system according to the invention, all of the benefits already described for a shifting element according to the first aspect invention are achieved.

There is furthermore claimed a cam shaft for actuating valves of an internal combustion engine, wherein the cam shaft comprises at least one shaft segment, a cam segment which is adapted to be shifted along a shaft axis of the shaft segment and a shifting element for shifting the cam segment. The shifting element has a guide groove for receiving an engagement element. The guide groove extends along an outer peripheral surface of the shifting element at least in sections and has an effective section for bringing about a rotational movement of the engagement element about its rotational axis, which extends orthogonally to a rotational axis of the shifting element. The effective section has a contact surface for the eccentric contacting of the engagement element. Advantageously, the cam segment and the shifting element are operatively connected to each other. It is conceivable that the cam segment and the shifting element are the same element, so that for example the guide track of the shifting element is formed sideways, that is axially spaced apart, from the cam tracks of the cam segment. It is furthermore conceivable that the cam segment and the shifting element are joined together by a further element, such as a guide sleeve.

In the described cam shaft, all of the benefits already described for a shifting element according to the first aspect of the invention or a shifting system according to the second aspect invention are achieved.

Sample embodiments of a shifting element according to the invention, a shifting system according to the invention, and a cam shaft according to the invention shall be explained more closely below with the aid of drawings. There are shown, each time schematically:

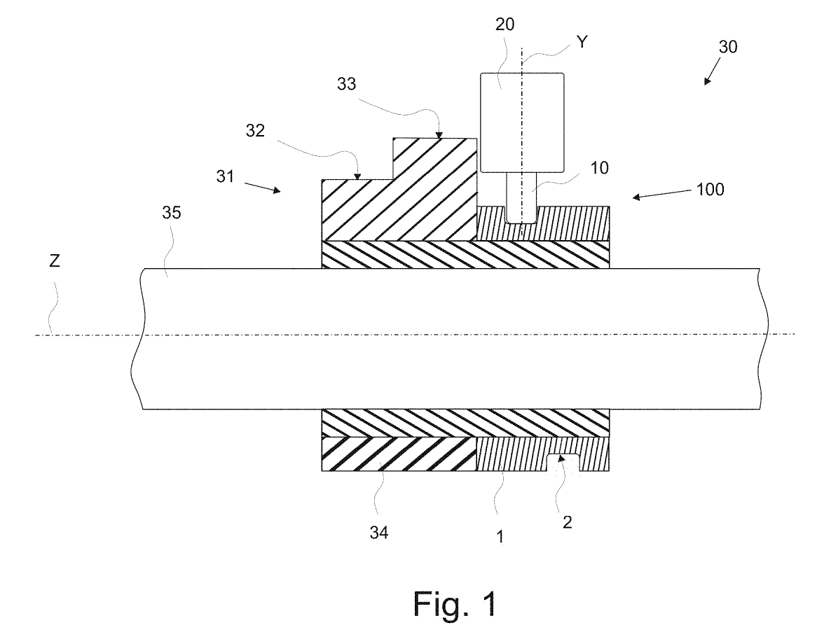

FIG. 1 in a side view, one embodiment of a cam shaft according to the invention,

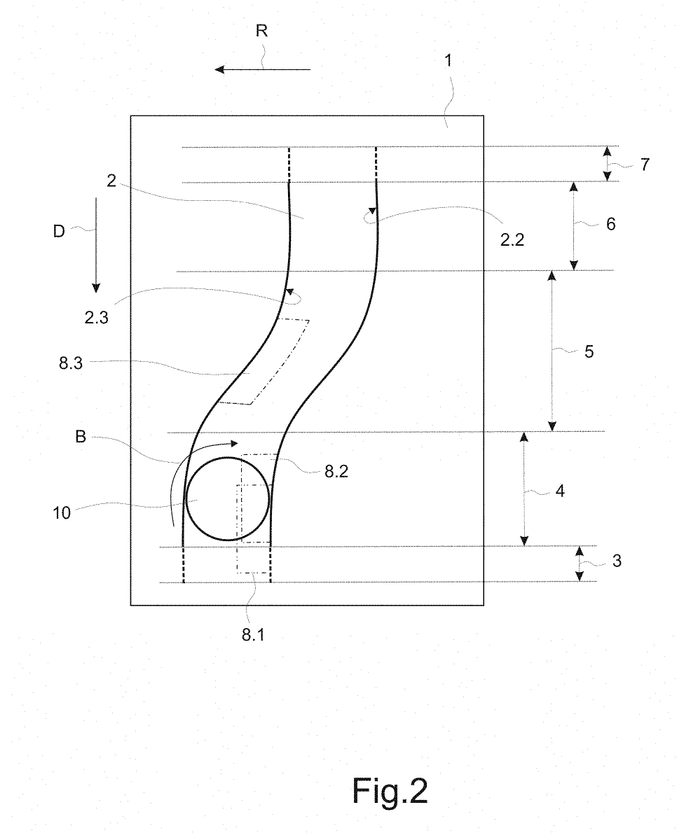

FIG. 2 in a top view, a developed embodiment of a shifting element according to the invention,

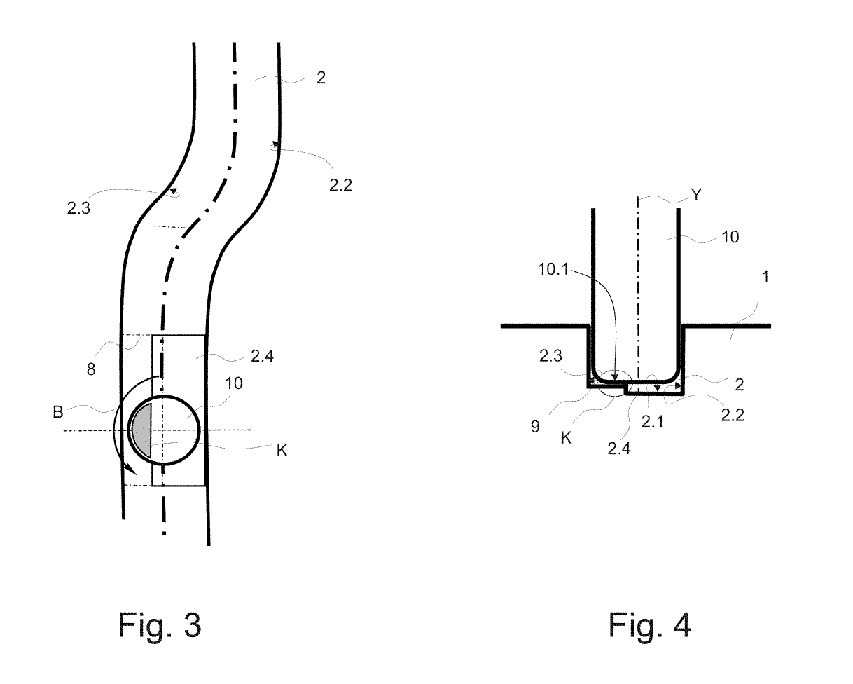

FIG. 3 in a top view, one embodiment of a shifting element according to the invention with a guide groove having an effective section,

FIG. 4 in a cross sectional side view, the embodiment shown in FIG. 3 of a shifting element according to the invention,

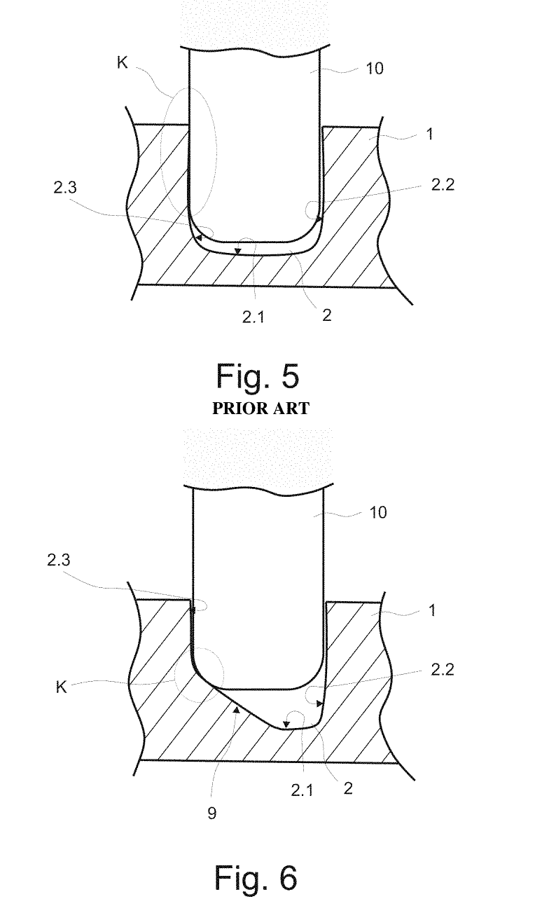

FIG. 5 in a cross sectional side view, a shifting element known from the basic prior art, and

FIG. 6 in a cross sectional side view, another embodiment of a shifting element according to the invention.

Elements with the same function and manner of working are provided with the same reference numbers in each case in FIGS. 1 to 6.

FIG. 1 shows, in a cross sectional side view, one embodiment of a cam shaft 30 according to the invention. The cam shaft 30 comprises a shaft segment 35 which extends in the axial direction along the rotational axis X through a corresponding opening of a guide sleeve 34. The guide sleeve 34 likewise extends in the axial direction along the rotational axis X, advantageously through continuous openings of a cam segment 31 and a shifting element 1, which is part of a shifting system 100. Advantageously, the guide sleeve 34 connects the cam segment 31 and the shifting element 1 to each other—directly or indirectly. Advantageously, the cam segment 31 and/or the shifting element 1 is connected by force locking or also form fitting or also by force locking and form fitting to the guide sleeve 34. Accordingly, it is conceivable that the cam segment 31 and/or the shifting element 1 are press-fitted or shrunk-fitted on the guide sleeve 34. The cam segment 31 has a first cam track 32 as well as a second cam track 33. The cam segment 31 and the shifting element 1 are arranged next to each other in the axial direction. The shifting element 1 furthermore has a guide groove 2, which extends in the circumferential direction of the shifting element 1. The guide groove 2 is engaged by an engagement element 10 of an actuator 20. The engagement element 10 extends along the longitudinal axis Y of the actuator 20. Advantageously, upon a contacting of the engagement element 10 with the guide groove bottom, especially a not otherwise represented contact element in the guide groove bottom, the engagement element 10 is rotated about its longitudinal axis Y. Consequently, the longitudinal axis Y is at the same time the rotational axis of the engagement element 10, which is oriented substantially orthogonal to the rotational axis X of the cam shaft 30, especially the shaft segment 35 of the cam shaft 30.

FIG. 2 shows, in top view, a developed embodiment of a shifting element 1 according to the invention. The shifting element 1 comprises a guide groove 2, in which an engagement element 10 engages. FIG. 2 furthermore shows an effective section 8.1, 8.2 and 8.3. The guide groove 2 can be divided into different sectors. Accordingly, the guide groove 2 consists for example of an entry sector 3, an inserting sector 4, an adjusting sector 5, a disengaging sector 6 and the exit sector 7. The entry sector 3 is created during the formation of the guide groove 2 in the material of the shifting element 1. The entry sector 3 is advantageously the region in which the guide groove bottom of the guide groove descends, starting from a base circle level of the shifting element 1, down to a defined depth of the groove bottom. The inserting sector 4 is the region of the guide groove 2 in which the engagement element 10 is inserted into the guide groove 2 of the shifting element 1. The inserting sector 4 advantageously has a straight trend of the guide groove 2. In the region of the inserting sector 4 the guide groove advantageously has the identical depth of the groove bottom, which also applies advantageously to the adjusting sector 5 and the disengaging sector 6. The adjusting sector 5 is the region in which the guide groove contour of the guide groove 2 experiences a deviation of the straight guidance in the circumferential direction of the shifting element 1. Consequently, upon movement of the shifting element 1 in the rotational direction D of the shifting element 1, the fixed-position engagement element 10 is moved indirectly along the guide groove 2—starting from the inserting sector 4 to the adjusting sector 5. Or the guide groove 2 is moved in the direction of movement or direction of rotation D such that the engagement element 10 moves from the inserting sector 4 to the adjusting sector 5. Thanks to the movement of the engagement element 10 along the guide groove 2 within the adjusting sector 5, there occurs a shifting movement of the shifting element 1 along the rotational axis X in the axial direction, that is, in the shifting direction R. Consequently, given an operative connection between a shifting element 1 and a cam segment, not shown here, the cam segment 31 operatively connected to the shifting element 1 (see FIG. 1) will also be moved in the shifting direction R. The disengaging sector 6 of the guide groove 2 is in particular the region in which the engagement element 10 is moved out or removed from the guide groove 2. Upon inserting or removing the engagement element into or out from the guide groove 2, the engagement element 10 advantageously experiences a translatory or rectilinear movement, especially in a direction orthogonal to the shifting direction or rotational direction D. Another sector of the guide groove 2 is the exit sector 7. In the region of the exit sector 7, the bottom of the guide groove 2 again rises up to the base circle level. Between the region of the exit sector 7 and the entry sector 3 advantageously no guide groove 2 is formed, so that the pure base circle of the shifting element 1 is present.

As can be seen from FIG. 2, it is conceivable that an effective section 8.1 is formed within the inserting sector 4 and the entry sector 3. Accordingly, it is conceivable that an effective section 8.1 extends at least in sections along the inserting sector 4 and likewise at least in sections along the entry sector 3. It is furthermore possible that an effective section 8.2 is formed only within the inserting sector 4. It is likewise possible that an effective section 8.3 is formed in the adjusting sector 5 of the guide groove 2. Advantageously, at least one effective section 8.2 is formed in the inserting sector 4 or in the inserting sector 4 and in the entry sector 3, while another effective section 8.3 is formed in the adjusting sector 5. Upon inserting the engagement element 10 into the guide groove 2 in the region of the inserting sector 4, at least one distal end of the engagement element 10 contacts a contact element of the effective section 8.1 or 8.2, not shown here, so that this results in producing a rotational movement of the engagement element 10 in the movement direction B of the engagement element 10. It is conceivable that the peripheral wall of the engagement element 10 contacts a side wall, such as the right side wall 2.2 of the guide groove 2 during the movement of the engagement element 10 along the guide groove 2 in the inserting sector 4. Thanks to the rotational movement of the engagement element 10 in the movement direction or rotation direction B, the engagement element 10 consequently rolls off along this side wall 2.2. As the movement of the shifting element 1 continues in the movement direction D, a peripheral wall of the inserting element 10 consequently impinges on a side wall 2.3 of the guide groove 2, so that a change in movement direction of the engagement element 10 is necessary in order to avoid or reduce the friction and abrasion of the material of the engagement element 10. Consequently, an effective section 8.3 is also advantageously formed in the adjusting sector 5 of the guide groove 2. The further effective section 8.3 advantageously results in a braking of the rotational movement of the engagement element 10 in the rotational direction B and also advantageously produces a rotation of the engagement element 10 opposite the movement direction B.

FIG. 3 shows a top view of an unrolled or unfolded guide groove 2 of one embodiment of a shifting element according to the invention. The guide groove two corresponds in its layout substantially to the guide groove 2 shown in FIG. 2 and is consequently advantageously S-shaped. The guide groove 2 has an effective section 8, which extends for example along the inserting sector or also along the entry sector and the inserting sector. In contrast with the effective sections 8.1 and 8.2 shown in FIG. 2, the effective section 8 of FIG. 3 is formed in the left region of the guide groove 2. In particular, the contact element not shown here is formed in the left region or in the left half of the guide groove 2, so that a contacting of a distal end of the engagement element 10 and of the contact element occurs in such a way that the engagement element 10 is accelerated in a movement direction B. This is illustrated in particular in FIG. 4, which represents the guide groove 2 shown in FIG. 3 in a cross sectional side view.

It is evident from FIG. 4 that the contact element 9 is formed in the left section or the left half of the guide groove 2. Advantageously, the contact element 9 is created by means of a material raising or by means of a recess 2.4 in the guide groove bottom 2.1. Based on the arrangement of the contact element 9 in the region of the guide groove bottom 2.1, a contact area K is formed between a distal end 10.1 of the engagement element 10 and the contact element 9, which is decentralized in regard to the engagement element 10. Based on the decentralized contacting of the contact element 9 with the engagement element 10, consequently there occurs on the one hand a resolving of the rotational movement of the engagement element 10 into the movement direction B. On the other hand, an abrasion of the material of the engagement element 10 occurs only in a decentralized distal region of the engagement element 10, which is noncritical, i.e., irrelevant to the preservation of the quality of guidance of the engagement element 10 inside the guide groove 2. As is shown in FIG. 4, it is conceivable for the contact element 9 to be designed in the form of a shoulder in the guide groove contour 2.1.

FIG. 5 shows, in a cross sectional side view, a cutout feature from an embodiment of a shifting element 1 with a guide groove 2 known from the basic prior art. The contact area K, which is formed between a side wall 2.3 of the guide groove 2 and an outer surface of the engagement element 10, results in an abrasion or wearing of the engagement element 10 as well as the guide groove 2 or the side wall 2.3 of the guide groove 2. Consequently, it is known from the prior art that, when an engagement element 10 is inserted into a guide groove 2, a direct contacting occurs between an outer peripheral wall of the shifting element 10 and at least one side wall 2.2 or 2.3 of the guide groove 2, on account of the comparable dimensions—in order to avoid a play during the movement of the shifting element 1 about its rotational axis between the engagement element 10 and the shifting element 1. Upon contacting of the engagement element 10 and the side wall 2.2 or 2.3 of the guide groove 2, a slip occurs between the engagement element 10 and the guide groove contour on account of the prevailing differential velocity between the engagement element 10, which as of yet still does not experience any rotational movement about its longitudinal axis Y, and the shifting element 1 moving in the movement direction D (see FIG. 2) during the acceleration phase of the engagement element 10 to the required rotational speed. This slip, in turn, results in wear on the engagement element 10 as well as the side wall 2.2 or 2.3 of the guide groove 2. On account of the progressive wearing down of the engagement element 10 and the guide groove contour of the guide groove 2, there is produced an unwanted play between the engagement element 10 and the guide groove contour, which has negative impact on the shifting behavior of the shifting element 1 and thus on the shifting of the individual valves of the internal combustion engine.

FIG. 6 shows, in a cross section side view, a cutout feature from one embodiment of a shifting element 1 according to the invention. As compared to the shifting element 1 of FIG. 5 represented according to the known prior art, the shifting element 1 shown in FIG. 6 has a guide groove 2 which has an unchanged side wall 2.2 as well as a side wall 2.3 and a guide groove bottom 2.1, between which a contact element 9 extends. Advantageously, the side walls 2.2 and 2.3 and the guide groove bottom 2.1 are not in direct contact with a surface of the engagement element 10. The contact element 9 is advantageously designed such that it extends substantially asymmetrically at least to the guide groove bottom 2.1 or to the side wall 2.3 of the guide groove 2. Advantageously, the contact element 9 is designed as a material raising and it creates a decentralized contacting between the guide groove contour and the engagement element 10. Consequently, the contact area K is formed between a decentralized distal end region 10.1 of the engagement element 10 and the contact element 9 of the guide groove 2. Advantageously in this way once again a rotational movement of the engagement element 10 is produced about its longitudinal axis Y, as well as a decentralized abrasion of the material of the engagement element 10 only in a distal end region 10.1 of the engagement element 10. Advantageously, however, no unwanted play is produced here between the side walls 2.1 and 2.3 of the guide groove 2 and the engagement element 10.

1.-10. (canceled)

11. A shifting element for shifting a cam segment along a shaft longitudinal axis of a shaft segment of a cam shaft, the shifting element comprising a guide groove for guiding an engagement element, the guide groove extending along an outer peripheral surface of the shifting element at least in part, wherein the guide groove has an effective section for causing a rotational movement of the engagement element about a rotational axis of the engagement element, wherein the rotational axis of the engagement element is orthogonal to a rotational axis of the shifting element, wherein the effective section has a contact element for eccentrically contacting the engagement element.

12. The shifting element of claim 11 wherein the effective section is disposed at least in part in an inserting sector of the guide groove in which the engagement element is adapted to be engaged with the guide groove.

13. The shifting element of claim 11 wherein the effective section is disposed at least in part in an adjusting sector of the guide groove where the guide groove deviates from a direction of travel.

14. The shifting element of claim 11 wherein the effective section is disposed at least in part in an entry sector of the guide groove where a groove bottom depth of the guide groove is continuously increasing.

15. The shifting element of claim 11 wherein the guide groove has a U-shaped contour and the contact element is disposed on a wall of the guide groove.

16. The shifting element of claim 11 wherein the contact element is a material rising that at least in part extends asymmetrically to a bottom of the guide groove within a contour of the guide groove.

17. The shifting element of claim 11 wherein the guide groove is Y-shaped, S-shaped, double S-shaped, or XS-shaped.

18. The shifting element of claim 11 comprising a guide sleeve that operatively connects the shifting element to the cam segment.

19. A shifting system for shifting a cam segment of a cam shaft, the shifting system comprising:
an engagement element that is rotatable about a longitudinal axis of the engagement element; and
a shifting element comprising a guide groove for guiding the engagement element, the guide groove extending along an outer peripheral surface of the shifting element at least in part, wherein the guide groove has an effective section for causing a rotational movement of the engagement element about the longitudinal axis of the engagement element, wherein the longitudinal axis of the engagement element is orthogonal to a rotational axis of the shifting element, wherein the effective section has a contact element for eccentrically contacting the engagement element.

20. The shifting system of claim 19 wherein the effective section is disposed at least in part in an entry sector of the guide groove where a groove bottom depth of the guide groove is continuously increasing.

21. The shifting system of claim 19 wherein the guide groove has a U-shaped contour and the contact element is disposed on a wall of the guide groove.

22. The shifting system of claim 19 comprising a guide sleeve that operatively connects the shifting element to the cam segment.

23. A cam shaft for actuating valves of an internal combustion engine, the cam shaft comprising:
a shaft segment;
a cam segment that is adapted to be shifted along a shaft longitudinal axis of the shaft segment;
a shifting element for shifting the cam segment, wherein the shifting element includes a guide groove for receiving an engagement element, the guide groove extending along an outer peripheral surface of the shifting element at least in part, wherein the guide groove includes an effective section for causing a rotation movement of the engagement element about a rotational axis of the engagement element, wherein the rotational axis of the engagement element is orthogonal to a rotational axis of the shifting element, wherein the effective section includes a contact surface for eccentrically contacting the engagement element.

24. The cam shaft of claim 23 wherein the effective section is disposed at least in part in an inserting sector of the guide groove in which the engagement element is adapted to be engaged with the guide groove.

25. The cam shaft of claim 23 wherein the effective section is disposed at least in part in an adjusting sector of the guide groove where the guide groove deviates from a direction of travel.

26. The cam shaft of claim 23 wherein the effective section is disposed at least in part in an entry sector of the guide groove where a groove bottom depth of the guide groove is continuously increasing.

27. The cam shaft of claim 23 wherein the guide groove has a U-shaped contour and the contact element is disposed on a wall of the guide groove.

28. The cam shaft of claim 23 wherein the contact element is a material rising that at least in part extends asymmetrically to a bottom of the guide groove within a contour of the guide groove.

29. The cam shaft of claim 23 wherein the guide groove is Y-shaped, S-shaped, double S-shaped, or XS-shaped.

30. The cam shaft of claim 23 comprising a guide sleeve that operatively connects the shifting element to the cam segment.
